(19) United States
(12) Patent Application Publication
(10) Pub. No.: US 2003/0221891 A1
(43) Pub. Date: Dec. 4, 2003

(54) Three-wheeled vehicle with a fender assembly and lighting system therefor

(76) Inventors: Berthold Fecteau, Richmond (CA); Bruno Girouard, Montreal (CA)

Correspondence Address: PILLSBURY WINTHROP, LLP, P.O. BOX 10500, MCLEAN, VA, 22102, US

(21) Appl. No.: 10/371,228

(22) Filed: Feb. 24, 2003

Related U.S. Application Data
(60) Provisional application No. 60/358,439, filed on Feb. 22, 2002.
(60) Provisional application No. 60/358,400, filed on Feb. 22, 2002.

(51) Int. Cl. B62K 5/02

(52) U.S. Cl. 180/210

(57) ABSTRACT

A three-wheeled vehicle is designed for road use and has an internal combustion engine that drives a single rear wheel and a pair of steerable front wheels. The front wheels are partially covered by a fender assembly that includes a fender body and a fender support. The fender support moves in correspondence with the front wheels independent of the main frame. The fender also includes a lamp that is flush with the fender body.

This application claims priority to U.S. Provisional Patent Applications No. 60/358,400 and No. 60/358,439, both filed Feb. 22, 2002. The subject matter of these applications is hereby incorporated herein by reference.

This application is also related but does not claim priority to the following U.S. provisional applications that were filed on Feb. 22, 2002: No. 60/358,362; No. 60/358,394; No. 60/358,390; No. 60/358,395; No. 60/358,436; No. 60/358,397; and, No. 60/358,398 and any non-provisional patent applications claiming priority to the same. This application is also related but does not claim priority to U.S. provisional application No. 60/358,737 filed on Feb. 25, 2002, and U.S. provisional application No. 60/418,355, which was filed on Oct. 16, 2002 and any non-provisional patent applications claiming priority to the same. The entirety of the subject matter of these applications is incorporated by reference herein.

This application is also related to but does not claim priority to U.S. Design application No. 29/155,964 filed on Feb. 22, 2002, and U.S. Design application No. 29/156,028 filed on Feb. 23, 2002. This application is also related to but does not claim priority to U.S. patent application Ser. No. 10/346,188 and U.S. patent application Ser. No. 10/346,189 which were filed on Jan. 17, 2003. The entirety of the subject matter of these applications is incorporated by reference herein.

### BACKGROUND OF THE INVENTION

1. Field of the Invention

This invention relates to vehicles, particularly vehicles designed for road use. Specifically, this invention is directed to three-wheeled vehicles driven by a power unit. In particular, this invention relates to the fender assembly for the steerable front wheels and the lighting arrangement on a three-wheeled vehicle.

2. Background of the Invention

Three-wheeled vehicle are known in general. There are several types of three wheeled vehicles known in the prior art. The first is the All Terrain Vehicle (or “ATV”) that was popularized in the 1980's. That vehicle had one front wheel and two rear wheels. It was specifically designed for off-road use and, therefore, did not have protective fenders or turn signals.

Another type of three wheeled vehicle know in the art is a three-wheeled motorcycle. A common example is a motorcycle with a single front wheel and two rear wheels. While qualified for road use, this type of motorcycle typically does not include fenders over the rear wheels. Moreover, even if the vehicle does include fenders, typically the motorcycle does not include turning signals separate and apart from the turning signals that are provided with the motorcycle.

A third type of three-wheeled vehicle known in the art is a motorcycle that has been modified to include two front wheels. Typically, the front part of the motorcycle is modified by attaching some sort of front suspension system from which the two front wheels may be suspended. On such a vehicle, it is not uncommon to include some sort of fender to protect the operator. However, as with the previous vehicle, the turning signals typically are those provided by the manufacturer of the motorcycle.

A desire has recently developed for a three-wheeled vehicle with two front wheels and a single rear wheel. In particular, a desire has arisen for a high-performance three-wheeled vehicle that is not merely an after market modification of a motorcycle.

Any vehicle manufactured for road use must comply with safety guidelines adopted by national and local motor vehicle agencies. One regulation requires-that turn signals be included on any road vehicle. One failing in the prior art that has been identified (when designing a three-wheeled vehicle for road use) is the positioning of the turn signals at the front of the vehicle. The prior art provides no guidance as to the positioning and design of the turn signals.

In addition, to protect the operator from debris thrown upwardly from the road surface by the front tires, it is known to provide a fender over the tires. There are, however, few examples in the prior art of fenders for use with three-wheeled vehicles, especially those where the front tires are not provided with a fender arrangement that is incorporated into the body of the vehicle. One example of such a fender design has been incorporated into the Plymouth® Prowler automobile, which was introduced by the Plymouth® company in the 1990's.

Despite this, a need has arisen, in connection with the design and development of a three-wheeled vehicle, for a suitable fender and fender attachment device.

In addition, in connection with the design and construction of a three-wheeled vehicle, it is desirable to provide adequate corrective cooling for the brakes at the front of the vehicle. The prior art provides little, if any, assistance in this regard.

In summary, there are at least three specific gaps in the prior art. The first concerns the design of turning signals for a three-wheeled vehicle. The second concerns the design of a fender for a three-wheeled vehicle. The third concerns the construction of a fender that assists with cooling of the brakes.

### SUMMARY OF THE INVENTION

An aspect of embodiments of this invention is to provide a three-wheeled straddle type vehicle having two wheels in the front and one wheel at the rear.

Another aspect of embodiments of this invention is to provide such a three-wheeled straddle type vehicle with front fenders that effectively shield an operator during use.

A further aspect of embodiments of this invention is to provide front fenders that are shaped to direct air onto the interior of the wheel so as to provide cooling to front disc brakes.

An additional aspect of this invention provides a three-wheeled straddle type vehicle having turning signals that are appropriate for road use and that are ergonomically designed.

A notable aspect of the three-wheeled vehicle according to this invention is that it is designed for road use, like a motorcycle. Off-road use is also contemplated, but it is not the primary focus of the design.

The three-wheeled vehicle in accordance with this invention includes a novel fender assembly in which the front fenders are supported for movement with the front wheels.

The fender assembly may also include integral lamps that function as hazard lights and/or turn signals. The lamps may be flush with the outer arcuate surface of the fender. The lamps can be positioned so that the driver may see the operation of the lamps but does not receive glare from the lamps.

Other objects, aspects and features of the invention will be apparent in view of the following description and drawings.

### BRIEF DESCRIPTION OF THE DRAWINGS

Referring to the drawings that form a part of the original disclosure:

FIG. 1 is a front view of the three-wheeled straddle-type vehicle in accordance with a preferred embodiment of the invention;

FIG. 2 is a side view of the three-wheeled vehicle of FIG. 1;

FIG. 3 is a top view of the three-wheeled vehicle of FIG. 1;

FIG. 4 is a front left perspective view of the frame assembly for the three-wheeled vehicle shown in FIGS. 1-3;

FIG. 5 is a left side view of the frame assembly of FIG. 4;

FIG. 6A is a rear perspective view of the inner side of the fender in accordance with a preferred embodiment of the invention;

FIG. 6B is a side view of the outer side of the fender of FIG. 6A;

FIG. 6C is a front perspective view of the fender of FIG. 6A;

FIG. 6D is an exploded side view of the fender of FIG. 6B showing the components of the lamp;

FIG. 7A is a side perspective view of the mounting assembly of the fender in accordance with a preferred embodiment of the invention;

FIG. 7B is another side perspective view of the mounting assembly of FIG. 7A; and

FIG. 7C is a side view of the fender mounting bracket.

### DETAILED DESCRIPTION OF PREFERRED EMBODIMENTS OF THE INVENTION

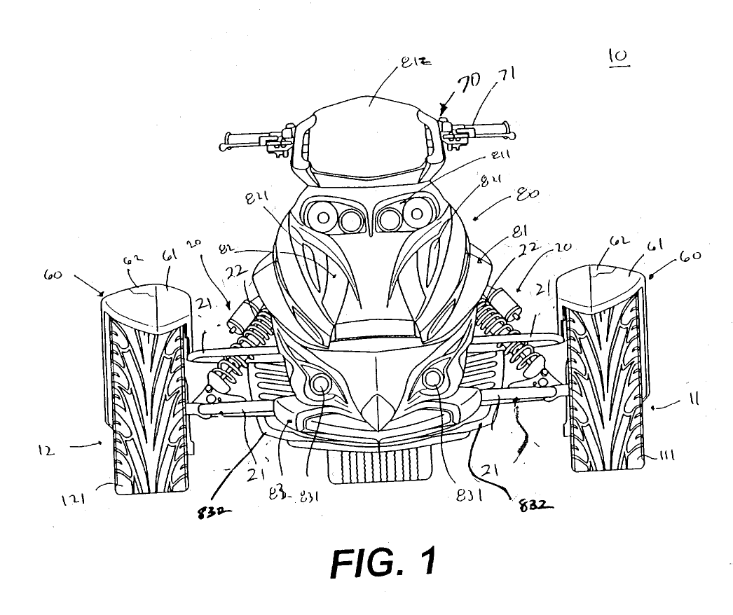

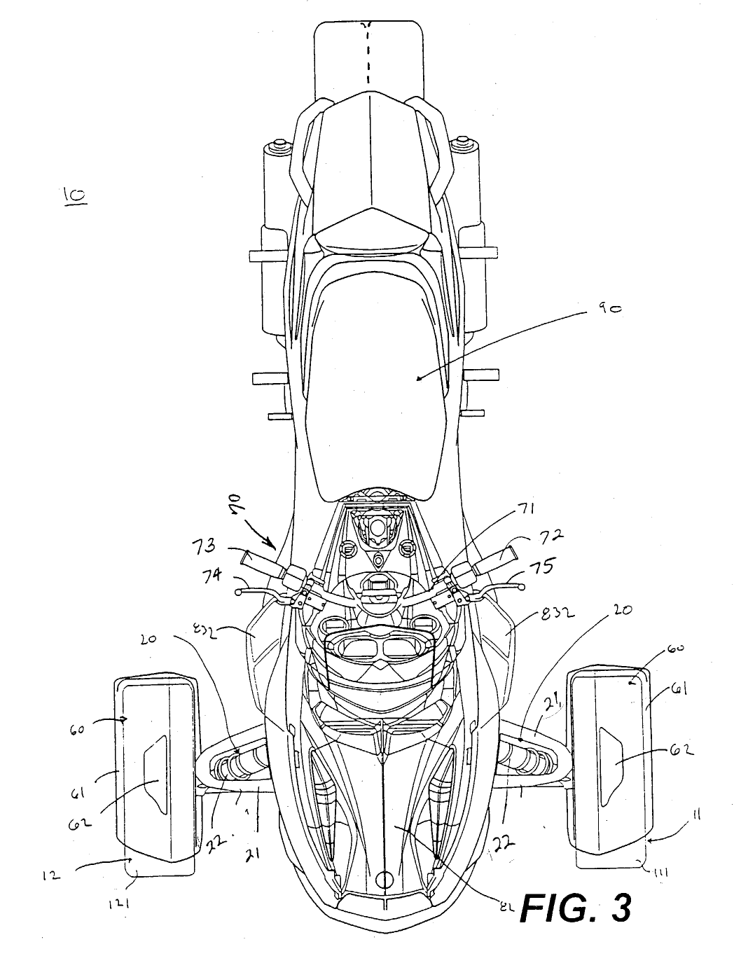

A three-wheel straddle type vehicle 10 in accordance with the present invention is generally illustrated in FIGS. 1-3. The vehicle 10 is designed with a straddle-type seat assembly 90 that preferably accommodates two adult-sized riders, a driver and a passenger. While the vehicle 10 is not designed to accommodate more than two adult-sized riders, the present invention contemplates that the design of vehicle 10 may be changed easily to accommodate more than two adult-sized riders.

It should be noted that the conventions “left,” “right,” “front,” “rear,” “up,” and “down” are defined according to the normal, forward travel direction of the vehicle. As a result, the “left” side of a vehicle corresponds to the left side of a rider seated in a forward-facing position on the vehicle.

The vehicle 10 is designed along a longitudinal axis and includes a left front wheel 11, a right front wheel 12 and a rear wheel 13. The front wheels 11 and 12 are equally offset from the longitudinal axis, and the rear wheel is aligned with the longitudinal axis. The left and right front wheels 11 and 12 have tires 111 and 121 secured thereto, respectively. The rear wheel 13 has tire 131 secure thereto. The rear wheel 13 may include multiple rims, with each rim accommodating a tire. In the case of a multi-rim arrangement, the rims would be rigidly connected to form a single wheel. For purposes of simplicity, when the rear tire is referred to in this application, it will be understood that the rear tire may include multiple tire components mounted on individual rims but acting as a single wheel.

The tires have a friction coefficient in accordance with the tire manufacturer's specifications. Preferably, each of the wheels 11, 12 and 13 is sized to accommodate a 15-inch automobile tire. The present invention, however, is not limited to equal sized wheels; rather, it is contemplated that the front wheels 11 and 12 may be smaller in size to accommodate a 13-inch automobile tires. Furthermore, other wheel sizes are considered to be well within the scope of the present invention.

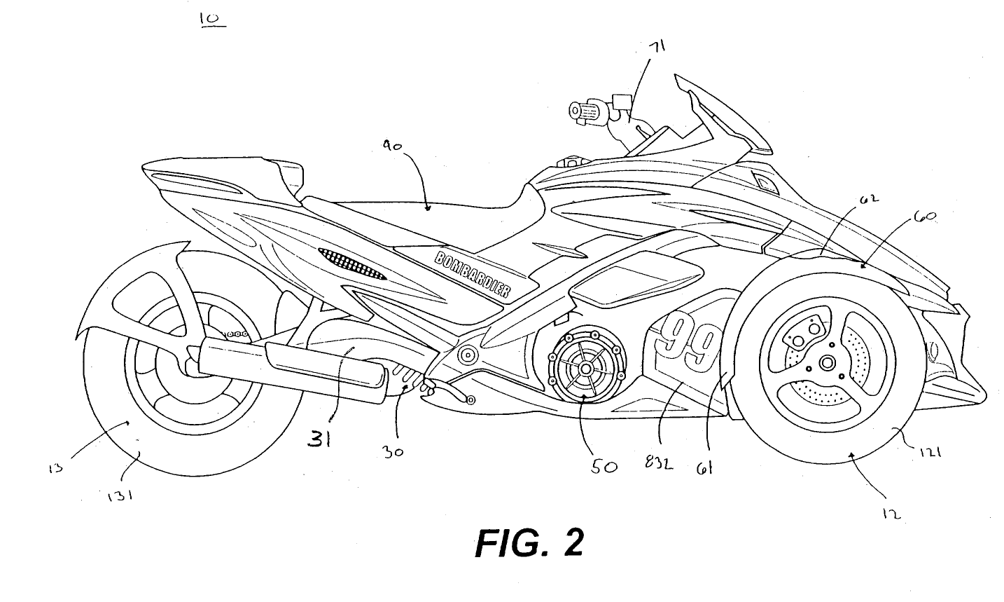

The front wheels 11 and 12 are supported by a front suspension assembly 20 and are controlled by the steering assembly 70. The rear wheel 13 is supported by a rear suspension assembly 30. The front suspension assembly 20 and the rear suspension assembly 30 are secured to a vehicle frame assembly 40, illustrated in FIG. 4. The front suspension assembly 20 includes a pair of suspension support arms (A-arms) 21 and a shock absorber 22 extending from each side of the frame assembly 40 to support each front wheel 11 and 12. The rear suspension assembly 30 includes a swing arm 31 (seen in FIG. 2) that pivotally connects to the frame assembly 40 by right and left laterally spaced rear suspension plates 41 and 42 at pivot axis 39 (seen in FIG. 4.)

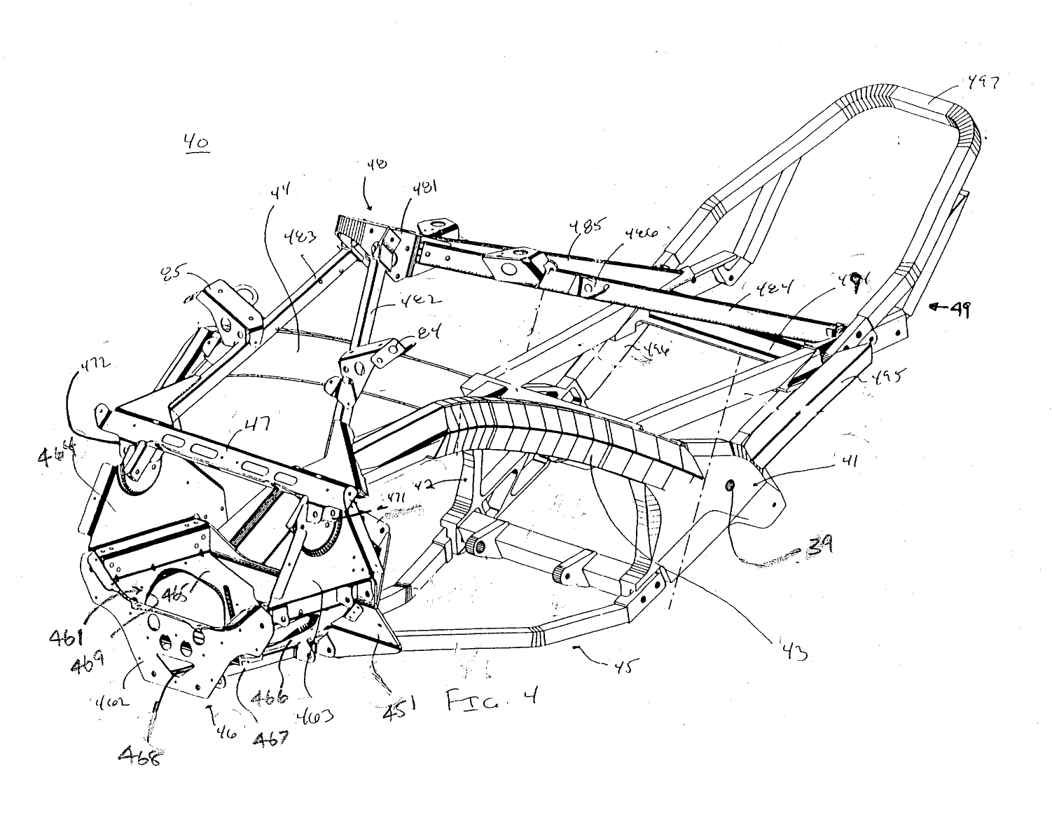

An engine 50 that drives the rear wheel 13 is secured to the vehicle frame assembly 40 adjacent to an engine cradle assembly 45, seen in FIGS. 4 and 5. The engine 50 may be secured directly to the frame assembly 40 at several points of attachment. Alternatively, the engine 50 may be secured to the frame assembly 40 using a suitable mounting assembly, not shown. The engine 50 is supported just behind the front suspension assembly 20 and is closely positioned to the horizontal. This positioning provides a lower center of gravity, which is useful in ensuring good handling and stability of the vehicle 10.

Because of the rigidity and improved structural strength of the frame assembly 40, the engine 50 can generate an output power of 80-135 horsepower or more. The frame assembly 40 provides sufficient structural rigidity to withstand the forces created during high performance operation of the vehicle 10. This is a significant improvement over conventional three-wheel ATVs, which were limited to an engine output of about 30 horsepower due to limitations in the structural strength of their frames, maneuverability and stability of their construction.

The engine 50 may be an internal combustion engine. Preferably, the engine 50 is a four-stroke engine, such as a 1000 cc four-stroke V-twin (V2) engine manufactured by ROTAX®. The vehicle 10 in accordance with the present invention, however, is not limited to a 1000 cc engine. It is also contemplated that a 600 cc engine also may be used. Furthermore, other engine displacement sizes are considered to be well within the scope of the present invention. Moreover, while a four-stroke engine is contemplated for use on the vehicle 10, a two-stroke engine also may be employed.

An engine cradle assembly 45 extends forwardly from the lower front ends of the rear suspension plates 41 and 42 to an engine cradle plate 451 that connects to the front suspension sub-frame 46. The engine 50 is supported within the frame assembly 40 at three different places (as viewed from the side.) Thus, the engine 50 itself adds structural rigidity to the frame assembly 40 by providing a structural connection between the front suspension sub-frame 46 and the rear suspension plates 41 and 42. As indicated above, while the engine 50 is contemplated as a structural element of the frame assembly 40, the engine 50 may be disposed on the frame assembly 40 in such a manner that it is not a structural member.

The front suspension assembly 20 is secured to the front suspension sub-frame 46, which includes a V-shaped plate 461 (when viewed from the front) with left and right outwardly extending side panels 465, 466. The rear edge of the V-shaped plate 461 is connected to the engine cradle plate 451. A longitudinally extending tubular beam 467 is connected to the inside of the vertex of the V-shaped plate 461. A forward transverse plate 462 is connected to the front end of the V-shaped plate 461. The plate 462 includes an opening 468 that is aligned with an opening in the engine cradle plate 451 through which air is directed through the frame assembly 40 to an oil cooler assembly (not shown).

Side panels 465, 466 each include large central apertures 469 through which the tie rods or steering linkages of the steering assembly 70 extend. Left and right vertically and longitudinally extending side panels 463 and 464 extend upwardly from the left and right side panels 465, 466 of the V-shaped plate 461. Each side panel 463 and 464 forms a triangle having a flat lower side attached to the V-shaped plate 461 when viewed from the side.

A laterally-extending front cross brace 47 connects between upper ends of the side panels 463 and 464 (i.e., at the upper vertices of the triangles formed by the side panels 463 and 464) of the front suspension sub-frame 46. Forward ends of the left and right upper spars 43 and 44 likewise connect to the front cross brace 47. The front cross brace 47 extends laterally outwardly beyond its connection points to provide left and right front suspension/shock absorber anchors 471 and 472 for the front suspension assembly 20.

A fender assembly 60 is associated with each of the front wheels 11 and 12. As shown in FIGS. 1 and 2, each fender assembly 60 includes a cover or body 61 that covers the top rear portion of the tires 111 and 121. The fender assembly 60 prevents dirt, water and road debris from being kicked up onto the rider, while the rider operates the vehicle 10. Each fender assembly 60 is linked to the front suspension assembly 20 and the steering assembly 70 such that the fender bodies 61 move together with the wheels 11 and 12 during steering of vehicle 10. This arrangement ensures that the tires 111 and 121 will not throw dirt, water and road debris at the driver or rider as the vehicle 10 turns. Each fender assembly 60 preferably includes at least one lamp 62, which is preferably a turn signal/parking light/hazard signal, located on the top surface of each body 61, as shown in FIGS. 1-3 and as described in detail below.

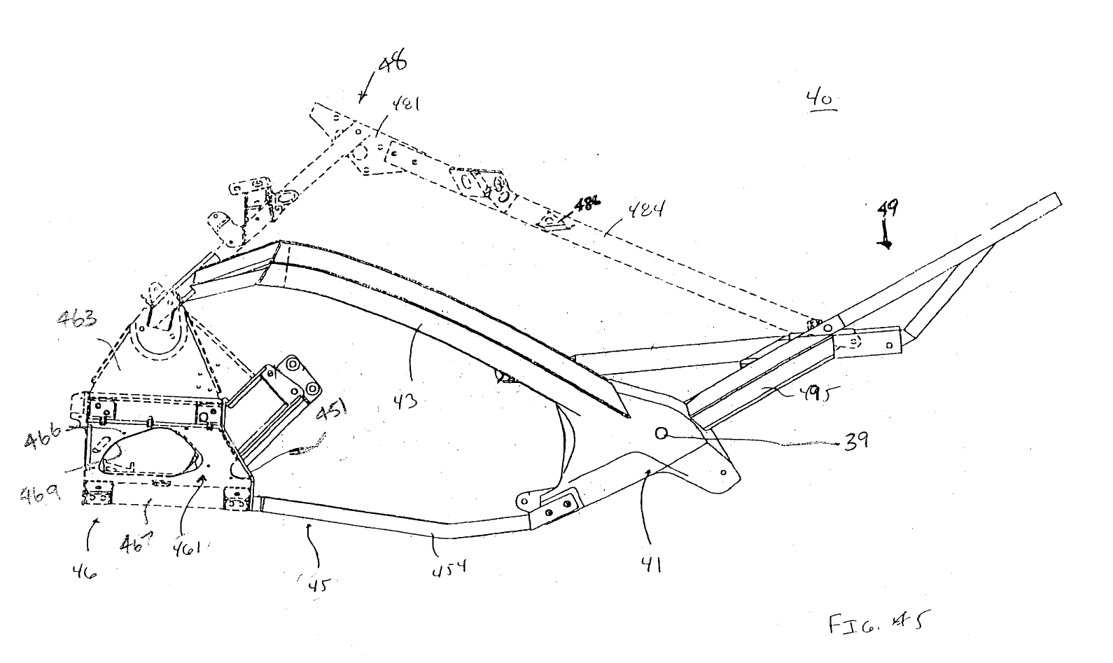

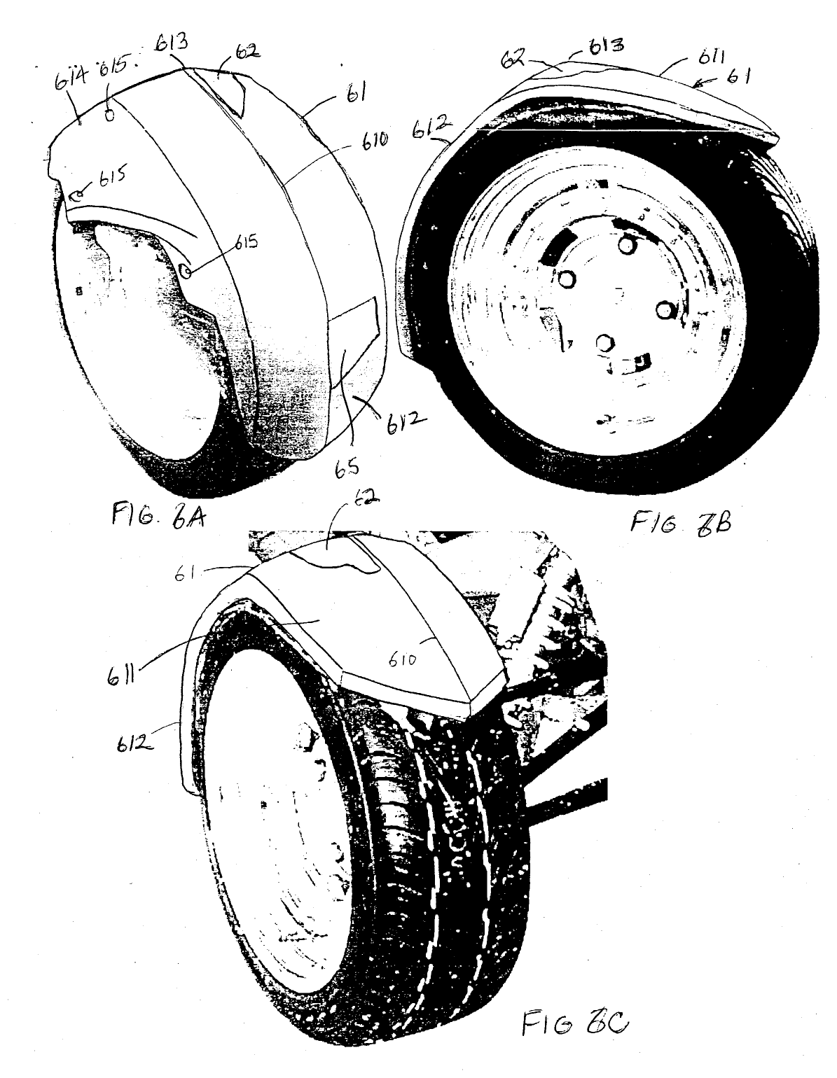

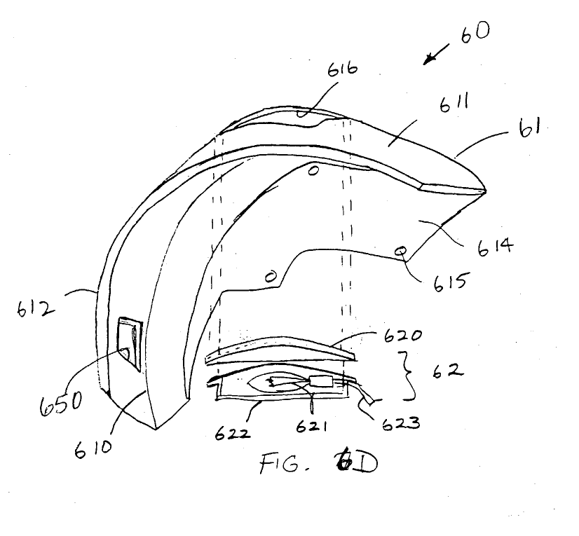

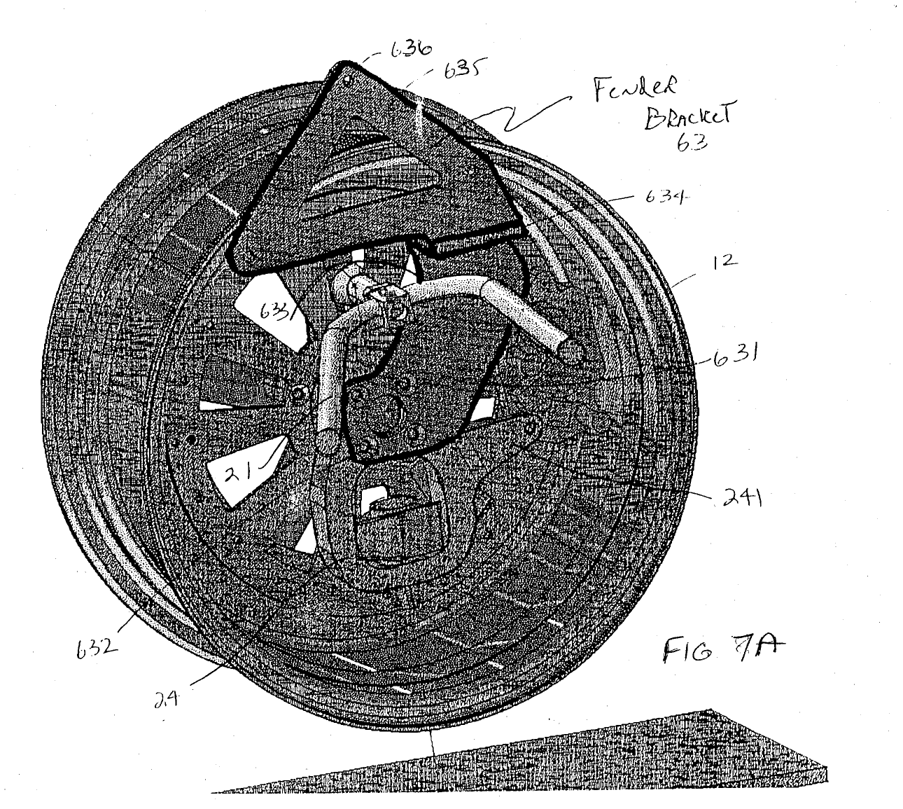

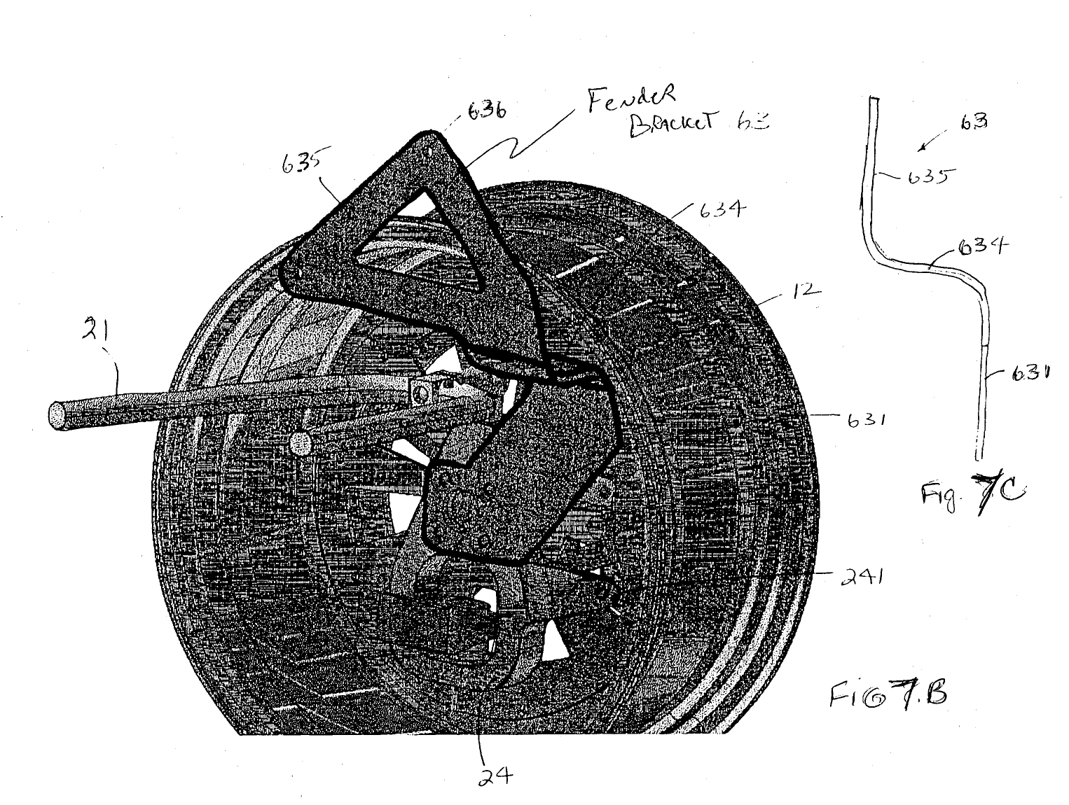

The front fender assemblies 60 on each side of the vehicle are mirror images of each other. As such, only one assembly 60 is described in detail. The front fender assembly 60 includes a fender body 61, shown in FIGS. 6A-6D, a fender support bracket 63, shown in FIGS. 7A-7B, and the lamp 62. The fender assembly 60 of FIGS. 6A-6D and 7A-7B corresponds to the right fender assembly. As will be understood by those of ordinary skill in the art, the precise shape of the fender body 61 can vary based on design preference. However, the body 61 is sized and shaped to sufficiently cover the wheel to provide adequate protection to the driver.

The body 61 is formed as an elongated arcuate cover with a longitudinal axis 610 around which the body bends slightly. The ends are preferably pointed. The front portion 611 of the body 61 is shorter in length than the rear portion 612 of the body 61 since the rear portion 612 is required to discourage debris from flying rearwardly during operation of the vehicle. The front portion 611 and the rear portion 612 meet at the apex 613 of the body 61. This shape is aerodynamic. Being constructed from a thermoplastic material, for example, the body 61 resists denting and deforming. As can be appreciated from FIG. 6A, the shape of the body 61 also creates a flow of air during operation that is directed toward the inside of the wheel 111 that provides cooling to the disc brake associated with the wheel 11.

A mounting flange 614 extends radially inward from the arcuate fender body 61. The mounting flange 614 provides a stable base support for the fender support bracket 63. A plurality of apertures 615 are provided in the mounting flange 614 for fastening the fender support bracket 63 to the body 61. Three apertures 615 are shown and are preferred for stability. However, any number of apertures and, accordingly, any type of fasteners, could be used.

An aperture 616, seen in FIG. 6D, is formed in the body 61 for mounting the lamp 62. Preferably, the aperture 616 is formed at the apex 613 of the body 61 so that the lamp 62, when mounted, can be seen from any angle, e.g., from the front, side and rear, and especially by the driver. As seen in FIGS. 6A-6C, the aperture 616 is positioned on the far side of body 61 from the operator. This positioning allows the operator to see the illumination of the lamp 62, but be shielded from direct glare of the lamp 62. The aperture 616 can be any shape desired.

A transparent lens 620, formed of a durable transparent material, such as plastic, is mounted within the aperture 616. It is preferred that the lens 620 be flush with the body 61 so that the exterior surface of the lens is coextensive with the outer surface of the body 61. However, the lens 620 may also be raised or protrude from the aperture 616 if desired. The lens 620 may be any suitable color, especially amber, which is traditionally used for turn signals and parking lights for road vehicles.

The lamp 62 can be formed as any conventional vehicle lamp. Preferably, the lamp 62 includes a light source 621, such as a light emitting diode (LED), a light housing 622, and an electrical connector 623 connected between the light source 621 and the electrical power source of the vehicle 10. The electrical connector 623 can be connected to an electrical component carried by the knuckle 24 or the support arms 21, as is conventionally known. The light source 621 can be any type of illumination device such as an LED or an incandescent bulb. Further, any number of illumination sources may be used, and they may constitute any of a variety of colors. The light housing 622 is preferably shaped to fit snugly against the inner surface of the fender body 61 so as to prevent debris from entering the light housing 622 and to not interfere with the vehicle wheel 11 or 12.

This lamp arrangement 62 adds enhanced safety features to the vehicle 10 in that the lamp 62 is easily seen by oncoming traffic, in addition to traffic directly behind and next to the vehicle. Moreover, the driver can easily confirm that the lights are on and are operating correctly.

In particular, the transparent lens 620 is designed to extend laterally outwardly from the longitudinal axis 610 of the body 61, away from the frame assembly 40. In addition, the transparent lens also extends forwardly and rearwardly from the apex 613 of the body 61. The construction provides two distinct advantages, among others. First, light from the light source 621 is directed rearwardly, laterally outward, and forwardly from the body 61. As a result, a person observing the vehicle 10 will see the light from the light source 621 at virtually every observational angle from a position exterior to the vehicle 10. Second, the longitudinal axis 610 establishes a light barrier that prevents light from the light source 621 from being directed to the operator of the vehicle 10. As a result, the operator is not distracted by the light source 621 during operation of the vehicle. In addition, since the operator of the vehicle 10 can see the transparent lens 620 from his or her vantage point, the operator can determine readily if the light source 621 is illuminated and functioning properly.

As seen in FIG. 6A, another lamp 65 may also be used on the fender 60. In this case, a lamp 65 is positioned at the rear portion 612 of the body 61 near the lower edge. Such a lamp 65 could be used as a brake light and/or turn signal, for example. An opening 651, seen in FIG. 6D, is provided in body 61 in which the lamp 65 is mounted. The lamp 65 may be a flush mount similar to lamp 62 or may protrude from the surface of the fender 60. The operation of the lamp 65 may be separate or in correspondence with the operation of lamp 62. It is also possible to just use a reflector in this location.

Referring to FIGS. 7A and 7B, wheel 12 is shown without a tire 121 mounted thereto. FIG. 7C is a side view of the fender mounting bracket 63 without the fender body 61 mounted thereto. The bracket 63 is preferably a generally C-shape with a lower portion 631 that is fastened to the wheel knuckle 24 at fastening formations 632. It is also possible to make the fender support integral or one piece with the wheel knuckle 24. However, it is preferred to have the bracket 63 easily removable for replacement.

The bracket 63 extends upwardly from the lower portion 631 around a central cut out portion 633 that permits the support arm 21 to be connected to the knuckle 24 without interference with the bracket 63. As can be appreciated from the FIG. 7C, the lower portion 631 is designed to be recessed within the wheel hub 12. A central portion 634 extends perpendicularly outward from the lower portion 631. The top of the bracket includes a mounting portion 635 that is preferably triangularly shaped. The top mounting portion 635 has a plurality of mounting formations 636, such as apertures for receiving fasteners. The mounting formations 636 are designed to match with the apertures 615 on the mounting flange 614 of the fender body 61. Again, preferably three formations 636 are provided for stability. Obviously, any number or type of mounting fasteners/apertures can be used. Additionally, the top mounting portion 635 can vary in shape. However, the triangular configuration provides a very strong and stable support for the fender assembly 60. The top mounting portion 635 extends inwardly from the wheel 12 so as to not interfere with the tire 121.

The bracket 63 is preferably made from a material that is strong yet flexible in order to absorb impacts and vibrations experienced by the wheels of the vehicle. Preferably, the bracket 63 is made from ¼ inch thick aluminum sheet metal that can twist and bend but still maintain its overall strength and shape. The bracket 63 functions as a shock absorber for the fender body 61.

It is preferred that the fender assembly 60 be positioned close to the wheel 11, 12 to maximize protection of the driver from debris thrown by the wheel and to optimize the aerodynamic nature of the fender body 61. Preferably, the fender body 61 is located less than 20 mm from the outer surface of the tire 111, 121. The more desirable spacing range is between 5-12 mm, most preferred is between 10-12 mm, with about 11 mm being the optimal spacing. With this desired spacing, the fender body 61 according to this invention is able to flex as a result of wheel impacts and vibrations yet maintain a safe spacing from the wheel surface. The bracket 63 according to this invention allows such flexure. It is preferred that the bracket 63 accommodates about 5 mm of movement, which would result from about 20 g of force (“g” being the standard acceleration of gravity) experienced by a typical road tire. By this arrangement, the fender assembly 60 is protected from damage by the forces experienced by the tires, as normally occur in road use, and also does not interfere with rotation of the wheel. Further, when the fender body 61 carries the lamp 62, the bracket 63 flexure protects the lamp assembly 62 from damage.

The steering of the front wheels 11 and 12 is accomplished through the use of the steering assembly 70. The steering assembly 70 includes handlebars 71 and conventional steering linkages (not shown in detail) connected to the wheels 11 and 12 for purposes of turning the wheels 11 and 12 in response to movement of the handlebars 71. The steering assembly 70 is connected to wheel knuckles 24 through the steering linkage at the steering linkage connection 241 on the knuckle 24. The knuckle 24 is attached to each wheel in a known manner. The front suspension assembly 20 is coupled to each knuckle 24 as seen in FIGS. 7A and 7B, with only the upper suspension support arm 21 being shown for purposes of clarity. As would be understood, the lower suspension support arm 21 is coupled to the lower portion of the knuckle 24. The shock absorber 22 can also be coupled to the knuckle 24 or to a bracket on the lower suspension support arm 21.

Therefore, in operation, when an operator turns the handlebars 71, the steering linkage is moved, which turns the wheels 11 and 12. Because the fender support brackets 63 are supported by the wheel knuckles 24, the fender assembly 60 turns in conjunction with the wheels 11 and 12. By this arrangement, the driver is protected by the fenders 61 at all times, even while turning, from the spray of water and the projection of debris from the roadway. Such protection is necessary since this vehicle 10 is designed for road use. This arrangement also allows a smaller, and hence lighter, fender assembly to be used.

If the fender was supported by the frame 40 or by the suspension assembly 20, the fender would not turn when the wheels are turned, as in conventional automobiles. Moreover, in a conventional arrangement, a larger, and hence heavier, fender assembly would be needed to ensure that sufficient coverage is provided to the operator from debris. In this invention, a smaller fender that turns with the front wheels can provide even more protection to the driver and passenger of this three-wheeled vehicle.

The steering assembly 70 of the vehicle 10 is preferably provided with a progressive steering system (not shown). The progressive steering system allows the handlebars 71 to be turned to their maximum position (about 50 degrees of arc), while the wheels 11 and 12 turn to an increasingly greater extent. The linkage between the handle bars 71 and the steering linkages that makes progressive steering possible must be designed so that small variations in the handle bars when the vehicle is travelling straight will not turn the wheels to any significant degree. In other words, when the vehicle 10 is travelling forward, especially at high speed, there should be a good amount of play in the handlebars so that small movements made by the driver do not result in a sudden (or unexpected) turning of the vehicle 10. On the other hand, when the handlebars are turned to a more significant displacement, the degree of play preferably should decrease as the angular displacement of the handle bars increases. In other words, the closer the handle bars are turned to their most rotated position, the less play there should be in the linkage between the handle bars and the wheels of the vehicle 10.

The front of the vehicle 10 includes a fairing assembly 80, which encloses the engine 50 to protect it and to provide an external shell that can be decorated so that the vehicle 10 is aesthetically pleasing. The fairing assembly 80 is preferably made from fiberglass having a gel coat. The fairing assembly 80 includes an upper portion 81, a hood 82 removably secured to the upper portion 81 and a bottom pan 83. The fairing assembly 80 is secured to the vehicle frame assembly 40 by a plurality of fairing anchors. At least two fairing anchors 84 and 85 are illustrated in FIG. 4.

The hood 82 includes at least one air intake opening 821 to provide a supply of air to an air box (not shown), which supplies air at least to the air intake of the engine 50. As previously mentioned, the hood 82 is removable to permit access to an interior storage compartment located in the front portion of the vehicle 10. The storage compartment offers the driver a place to store personal belongings when the vehicle 10 is parked in a public location. The storage compartment is removable to permit access to the engine 50. The upper portion 81 of the fairing assembly 80 further includes a cluster of headlamps 811. A windshield 812 may be connected to the upper portion 81 of the fairing assembly 80 near the front section or preferably to the steering assembly 70 adjacent the handlebars 71, as shown in FIG. 1.

The bottom pan 83 of the fairing assembly 80 may also include one or more fog lamps 831. The bottom pan 83 has a pair of lateral extensions protruding therefrom, which form radiator covers 832. The radiator covers 832 surround and protect a pair of laterally spaced radiator assemblies, which together form a radiator for the engine 50. The radiator covers 832 also function to provide a windbreak for the feet and lower legs of the driver. The radiators permit liquid cooling of the engine 50. The liquid coolant is cooled by air, as is known in the art, and may additionally aided by an automatic fan installed ahead of (or behind) the radiator when the vehicle 10 is idling for an extended period of time.

The vehicle 10 includes a cushioned rider seat assembly 90 that is mounted to the frame assembly 40 between the front wheels 11 and 12 and the rear wheel 13, as shown in FIGS. 1-3. The seat assembly 90 is connected to an upper support assembly 48 and a seat support assembly 49 of the vehicle frame assembly 40. The seat support assembly 49 is connected to the suspension plates 41 and 42 through rear suspension link supports 495 and 496. The upper support assembly 48 includes a steering column bracket 481. A pair of front supports 482 and 483 extend from the front brace 47 to the steering column bracket 481. The supports 482 and 483 include fairing anchors 84 and 85. A pair of rear supports 484 and 485 extend rearwardly from the steering column bracket 481 towards the seat support assembly 49. The rear supports 484 and 485 include seat anchors 486 and 487 for securing a front portion of the seat assembly 90 thereto.

The cushioned seat assembly 90 is mounted to the seat anchors 486 and 487 and rests on the rear supports 484 and 485 and the U-shaped seat frame 497. The seat assembly 90 is positioned so that a weight of the rider thereon will be disposed generally above the rear suspension cross brace 494, which supports the rear suspension links. Consequently, the weight of the rider will be transferred through the seat assembly 90 and frame assembly 40 to the rear suspension cross brace 494, and from the rear suspension cross brace 494 to the rear suspension assembly 30, and to the front suspension sub-frame 46 and front suspension assembly 20 through the front supports 482 and 483.

Other conventional components of a drive system and a road vehicle are provided as seen in the figures but need not be described in detail as one of ordinary skill in the art would readily recognize the remaining components.

All of the above noted dimensions are provided for purposes of description and are in no way intended to be limiting. The various parameters could of course be varied and remain within the scope of the invention. Further, the size of the various components that may appear in the drawings can vary from the size shown.

The embodiments described herein are intended to be illustrative of this invention. As will be recognized by those of ordinary skill in the art, various modifications, combination of features, equivalent arrangements and changes can be made and would remain within the scope of the invention defined in the appended claims.

What is claimed is:

1. A three-wheeled vehicle, comprising:
an engine and an electrical power source;
a frame, wherein the engine is mounted within the frame;
a pair of front wheels supported by the frame and a single rear wheel supported by the frame, the rear wheel being operatively connected to the engine such that the engine drives the rear wheel;
tires mounted on each of the wheels, wherein the tires are suitable for road use;
a steering mechanism supported by the frame and coupled to each front wheel to move the front wheels for steering;
a straddle seat supported by the frame disposed between the front wheels and the rear wheel; and
a fender supported by the frame and mounted over a portion of each front wheel for movement therewith, the fender having a body having an outer surface with an aperture therein and an inner surface, and wherein each fender includes a lamp connected to the electrical power source, the lamp being mounted within the aperture.

2. The vehicle of claim 1, wherein the lamp includes a lens mounted within the aperture, a light housing supported by the body, a light mounted within the housing, and an electrical connector coupled to the light and connected to the electrical power source.

3. The vehicle of claim 2, wherein the lens is flush with the outer surface.

4. The vehicle of claim 2, wherein the outer surface is arcuate.

5. The vehicle of claim 2, wherein the light housing is fastened to the inner surface of the body.

6. The vehicle of claim 2, wherein the light housing is integrally molded with the body.

7. The vehicle of claim 2, wherein the light is an light emitting diode (LED).

8. The vehicle of claim 2, wherein the light housing is positioned at least partially beneath the lens.

9. The vehicle of claim 1, wherein the engine is a four stroke internal combustion engine.

10. The vehicle of claim 1, wherein the fender includes a mounting bracket, wherein the mounting bracket is flexible.

11. The vehicle of claim 1, wherein the body of the fender has an apex and the aperture is positioned generally at the apex such that the lamp is positioned at the top of the wheel.

12. The vehicle of claim 1, wherein the body of the fender has a longitudinal axis that has a peak, wherein the aperture is positioned on a side of the longitudinal axis opposed to the vehicle frame.

13. The vehicle of claim 1, further comprising a wheel knuckle mounted to each front wheel and a pair of arms pivotally supported by the frame, with one arm extending from each side of the frame to one of the wheel knuckles, and a pair of shock absorbers, with one shock absorber extending from each side of the frame to one of the wheel knuckles, and wherein each fender is mounted to one of the wheel knuckles.

14. A three-wheeled vehicle, comprising:
an engine and an electrical power source;
a frame, wherein the engine is mounted within the frame;
a pair of front wheels supported by the frame and a single rear wheel supported by the frame, the rear wheel being operatively connected to the engine such that the engine drives the rear wheel;
tires mounted on each of the wheels, wherein the tires are suitable for road use;
a steering mechanism supported by the frame and coupled to each front wheel to move the front wheels for steering;
a straddle seat supported by the frame disposed between the front wheels and the rear wheel;
a fender supported by the frame and mounted over a portion of each front wheel for movement therewith, such that the fender articulates with respect to the frame; and
a lamp connected to the electrical power source, the lamp being mounted on the fender.

15. The vehicle of claim 14, wherein the fender has a body with an aperture formed therein and the lamp includes a light housing mounted on an underside of the body, a light mounted in the light housing. and an electrical connector coupled to the light and connected to the electrical power source.

16. The vehicle of claim 15, further comprising a lens mounted over the light housing in the aperture such that the lens is flush with an outer surface of the body.

17. The vehicle of claim 16, wherein the body is arcuate.

18. The vehicle of claim 14, wherein the light is an light emitting diode (LED).

19. The vehicle of claim 14, wherein the engine is a four stroke internal combustion engine.

20. The vehicle of claim 14, wherein the fender includes a mounting bracket secured to the frame, wherein the mounting bracket is flexible.

21. The vehicle of claim 14, wherein the fender has an apex and the lamp is positioned generally at the apex such that the lamp is positioned at the top of the wheel.

22. The vehicle of claim 14, wherein the fender has a longitudinal axis that has a peak, wherein the lamp is positioned on a side of the longitudinal axis opposed to the vehicle frame.

23. The vehicle of claim 14, further comprising a wheel knuckle mounted to each front wheel and a pair of arms pivotally supported by the frame, with one arm extending from each side of the frame to one of the wheel knuckles, and a pair of shock absorbers, with one shock absorber extending from each side of the frame to one of the wheel knuckles, and wherein each fender is mounted to one of the wheel knuckles.
